(19) United States
(12) Patent Application Publication
(10) Pub. No.: US 2006/0194898 A1
(43) Pub. Date: Aug. 31, 2006

(54) Puncture sealing composition and tire

(76) Inventor: Joseph C. Sanda JR., Taylors, SC (US)

Correspondence Address: MICHELIN NORTH AMERICA, INC., 515 MICHELIN ROAD, P.O. BOX 2026, GREENVILLE, SC, 29602, US

(21) Appl. No.: 10/632,321

(22) Filed: Aug. 1, 2003

Related U.S. Application Data
(60) Provisional application No. 60/400,493, filed on Aug. 1, 2002.

(51) Int. Cl. B29C 73/00

(52) U.S. Cl. 523/166

(57) ABSTRACT

The present invention is a pneumatic tire of the tubeless type, embodying a layer of puncture sealant composition based on: A. a minor proportion of a low molecular weight elastomer (e.g., depolymerized natural rubber) in admixture with a tackifying or plasticizing substance (e.g., a resinous reaction product of a mineral oil purification residue with formaldehyde) and B. a major proportion of a high molecular weight elastomer (e.g., cis-polyisoprene); Containing a crosslinking agent (e.g., isopropyl titanate) in an amount sufficient to give a partial cure; and C. ground rubber from used tires in the amount of up to 5 percent by weight of the sealant composition.

### FIELD OF THE INVENTION

The present invention is in the field of pneumatic tires.

### BACKGROUND OF THE INVENTION

Puncture sealing tubeless tires have previously been proposed, containing, in the area of the tire normally most subject to punctures (that is, the undertread or the area extending across the crown of the tire at least from one shoulder to the other), a layer of sealant composition which has plastic and adhesive qualities such that the composition tends to stick to a puncturing object, and, when the puncturing object is withdrawn, tends to flow into the opening or puncture, forming a plug which seals the opening against loss of air from the tires. Unfortunately, it has proven difficult to provide a composition that would flow into the puncture hole and yet have sufficient viscosity to prevent it from flowing at elevated temperatures, up to 250 degrees Fahrenheit, such as exist in an automobile pneumatic tire under operating conditions. The problem is complicated by the extreme centrifugal force to which the composition is subjected as the tire rotates at high speed, since such centrifugal force tends to cause the composition to flow into the central crown area, leaving the areas near the shoulders unprotected. Furthermore, it has proven difficult to provide a sealant composition that would retain this desired balance of viscosity, plasticity, adhesion and conformability over an extended period of service.

A number of patents employ unvulcanized, partially vulcanized, or fully vulcanized elastomeric layers as puncture sealants in pneumatic tires. Among them are U.S. Pat. Nos. 4,064,922; 4,012,567; 5,085,942; and 2,765,018. However, there is a need for tire with an improved puncture sealant.

### SUMMARY OF THE INVENTION

The present invention is a pneumatic tire of the tubeless type, embodying a layer of puncture sealant composition based on: A. a minor proportion of a low molecular weight elastomer (e.g., depolymerized natural rubber) in admixture with a tackifying or plasticizing substance (e.g., a resinous reaction product of a mineral oil purification residue with formaldehyde) and B. a major proportion of a high molecular weight elastomer (e.g., cis-polyisoprene); Containing a crosslinking agent (e.g., tetra-isopropyl titanate) in an amount sufficient to give a partial cure; and C. ground rubber from used tires in the amount of up to 5 percent by weight of the sealant composition.

### BRIEF DESCRIPTION OF THE FIGURES

FIG. 1 is a sectional view of a tire showing a nail which penetrated the tire, the aperture resulting therefrom, and the puncture sealant composition filling the aperture.

### DETAILED DESCRIPTION OF THE INVENTION

The invention is a puncture sealant composition which is a mixture of low molecular weight liquid elastomer with a high molecular weight elastomer, the low molecular weight elastomer being present in amount less than 50% based on the weight of the two polymers, and ground rubber from used tires in the amount of up to 5 percent by weight of the sealant composition. The composition is crosslinked to an extent, as measured by gel and Mooney viscosity, which will prevent it from flowing at elevated temperature, yet still possess sufficient adhesion and conformability to function as a sealant. Preferably, a tackifier may be substituted for a portion of the low molecular weight rubber to enhance the adhesion and conformability of the resultant composition.

As the high molecular weight elastomeric component of the sealant composition of the invention there may be employed any high molecular weight solid elastomer capable of being crosslinked. Examples are the highly unsaturated rubbers such as those based on conjugated diolefins, whether homopolymers as in polyisoprene (particularly cis-polyisoprene, whether natural or synthetic), polybutadiene (including polybutadiene of high cis content), polychloroprene (neoprene), or copolymers as exemplified by those having a major proportion of such conjugated dienes as butadiene with a minor proportion of such monoethylenically unsaturated copolymerizable monomers as styrene or acrylonitrile. Alternatively, elastomers of low unsaturation may be used, notably butyl type rubbers (copolymers of such isoolefins as isobutylene with small amounts of conjugated dienes such as isoprene), or EPDM types (copolymers of at least two different monoolefins such as ethylene and propylene with a small amount of a non-conjugated diene such as dicyclopentadiene, 1,4-hexadiene, 5-ethylidene-2-norbornene, etc.). Even saturated elastomers such as EPM or ethylene-vinyl accetate may be employed, using the proper cure system. The elastomer may be emulsion-prepared or solution-prepared, stereo specific or otherwise. The molecular weight of the solid elastomer is usually in excess of 50,000 ordinarily within the range of from 60,000 to 2 to 3 million or more. Ordinarily the solid elastomeric component has a Mooney viscosity within the range of from 20 to 160 ML-4 at 212 degrees Fahrenheit.

The low molecular weight elastomer employed has a molecular weight less than 50,000, usually within the range from 1,000 to 10,000, and is preferably of the “liquid” rubber type with a maximum Brookfield viscosity at 150 degree F. of 2 million cps. ordinarily within the range of from 20,000 to 1 million cps. Examples are: liquid cis-polyisoprene (e.g., heat depolymerized natural rubber, or cis-polyisoprene polymerized to low molecular weight), liquid polybutadiene, liquid polybutene, liquid EPDM, and liquid butyl rubber. The high molecular weight, elongation and film strength of cis-polyisoprene (both natural and synthetic) and great tackiness of depolymerized cis-polyisoprene give a combination of these two elastomers, when partially cured, according to the present invention, a large degree of resistance to flow, coupled with efficient sealing ability. Other elastomer combinations of the present invention, particularly the saturated ones, offer resistance to oxidation in service which makes them also highly desirable.

Crumb Rubber

Crumb rubber is the name given to any material derived by reducing scrap tire or other rubber into uniform granules with the inherent reinforcing materials such as steel and fiber removed along with any other type of inert contaminants such as dust, glass, or rock. It is fine granular or powdered rubber capable of being used to make a variety of products. It is recovered from scrap tires using thermal or mechanical processing techniques. A variety of methods may be employed, including grinding at low temperatures (i.e., cryo-grinding). Crumb rubber also is derived from the tire retreading process, when worn tire tread is removed during a buffing process before the new tread is affixed. In one embodiment of the invention, the crumb rubber is 40 mesh crumb rubber, or finer.

For the purpose of the present application, the term “ground rubber” is equivalent to the term “crumb rubber.”

The present invention provides an excellent use for what otherwise might be discarded as a waste product, along with the 280 million tires discarded in the United States per year, and the 300 million others in piles nationwide.

The tackifying or plasticizing substances which are preferably included in the composition are low molecular weight materials such as rosin esters; aliphatic petroleum hydrocarbon resins (e.g., Piccopale™ 100SF (Loos & Dilworth, Bristol, Pa.)); polyterpene resins derived from alpha-pinene, beta-pinene; resins made from styrene and related monomers; resins made from dicyclopentadiene; and resins from the reaction of a mineral oil purification residue with formaldehyde and with nitric acid catalyst according to U.S. Pat. No. 3,544,494, Schmidt et al., Dec. 1, 1970, sold under the tradename of Struktol™; or resins such as Promix 400 by Flow Polymers, Inc. (Cleveland, Ohio); and Escorez 1102 (CAS # 68478-07-9, Exxon Mobil Chemical).

The sealant composition of the invention contains a minor proportion, that is, less than 50% by weight of total low molecular weight material (i.e., low molecular weight elastomer plus low molecular weight tackifier) based on the weight of the two elastomers plus tackifier or plasticizer, and ground rubber from used tires in the amount of up to 5 percent by weight of the sealant composition. The amount of tackifier or plasticizer may range up to 70%, based on the weight of low molecular weight elastomer plus tackifier or plasticizer and dispersing agent. The ratio of high to low molecular weight components depends mainly on the molecular weight of the high molecular weight elastomer and other variables such as the particular elastomer involved, the amount and kind of crosslinking agent, and the conditions of the crosslinking treatment. The proportion of the two elastomeric components are chosen so as to give a peak Mooney viscosity at 150 degrees F. (the maximum reading attained, which is usually at about 90 seconds of the 4 minute Mooney curve) of between 15 and 55 (large rotor, ML) in the final crosslinked mixture, with a preferred range of 20 to 45. Below an initial Mooney viscosity of 20, the composition will tend to flow down from the shoulder and sidewall areas of the tire when it is run at high speed as well as out of the hole when the tire is punctured. Above the said peak Mooney viscosity of 55, the sealant capability of the composition is sufficiently impaired to render it unusable for practical purposes. The Mooney viscosity of the mixture can also be controlled for a given elastomeric composition of the present invention by the amount of the mechanical shearing employed in mixing the constituents. The net effect here, of course, is to break down (i.e., lower) the molecular weight of the high molecular weight component, thereby lowering the Mooney viscosity before cure.

As indicated, for purposes of the invention the mixture further includes a crosslinking agent. The crosslinking agent may be any suitable substance or combination of substances capable of curing or gelling the mixture to the desired extent. Examples are:

1. Sulfur curing systems such as those based on sulfur or sulfur-yielding materials (e.g., tetramethyl thiuram disulfide) and conventional accelerators of sulfur vulcanization.

2. Quinoid curing systems such as p-quinone dioxime (GMF™, Uniroyal Chemical) with or without supplementary oxidant.

3. Organic peroxides (or hydroperoxides) such as dicumyl peroxide, cumene hydroperoxide, methyl ethyl ketone hydroperoxide or other radical generating catalysts such as azobisisobutyronitrile.

4. Polyisocyanates such as MDI (4,4′-methylene bis-phenyleneisocyanate), TDI (tolylene diisocyanate), and PAPI (polymethylene polyphenylisocyanate) as well as dimers and trimers of MDI and TDI.

5. Tetrahydrocarbyl titanate esters as described in U.S. Pat. No. 4,012,567 referred to above.

Another conventional way of crosslinking rubber is by electron radiation, which utilizes no added crosslinking agent.

The amount of crosslinking agent employed will vary with the particular elastomers employed and with their proportions, as well as with the particular crosslinking agent and the conditions of the crosslinking step. Ordinarily the amount used is that sufficient to prevent flow of the composition in a tire at temperatures up to 200 degrees F. and speeds up to 70 mph, while still retaining sufficient adhesiveness and conformability to perform the described sealant function. The amounts employed will vary depending on the proportion of high molecular weight elastomer in the mixture. Higher proportions of high molecular weight elastomer will require less crosslinking agent and vice-versa to maintain the desired combination of resistance to flow and sealing ability. The amount of crosslinking agent will, of course, vary with the nature of the elastomers themselves. For a depolymerized natural rubber (DPR) natural rubber (NR) mixture, the amount of sulfur-containing or quinoid type curative will be in the range of from more than 0.5 to 2.0 phr (parts per 100 parts by weight of both elastomers added together), ordinarily from 0.7 to 1.5 phr. For this same mixture, with polyisocyanate or hydrocarbyl titanate ester curatives, the amounts required will ordinarily be in the range from about 2 to 10 phr, preferably 2.5 to 8 phr. Similarly, the applicable range for peroxide or hydroperoxide curatives (radical generating catalysts) would be 0.1 to 1.0 phr, preferably 0.2 to 0.7 phr.

The crosslinking of the sealant mixture is accompanied by an increase in viscosity and an increase in the gel content (content of insoluble material). It has been found that for the natural rubber—depolymerized natural rubber mixture, a gel content, as measured in toluene at room temperature, of between 15 to 60% preferably 20 to 50%, by weight, in the crosslinked blend correlates with the desirable combination of sealing ability and lack of flow properties. For other elastomer combinations the range of optimum gel content will vary depending on the molecular weight and proportion of the two elastomeric components. As described previously, a peak Mooney viscosity (ML at 150 degrees F.) of between 15 and 55, preferably 20-45, of the final cured mixture has been found to correlate with the aforementioned desired combination of properties.

The crosslinking may be carried out at ordinary ambient temperature or at elevated temperature, depending on the temperature at which the particular crosslinking system selected is active in the particular elastomer combination employed.

The composition may further include, if desired, various appropriate additional compounding ingredients such as pigments such as carbon black, particulate inorganic fillers, extenders, tackifiers, stabilizers and antioxidants. It is not necessary, neither is it desirable to add fibrous fillers to the present compositions.

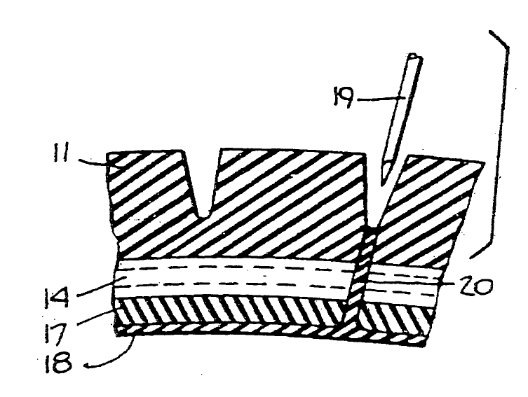

In practicing the invention the ingredients are mixed together uniformly and the resulting mixture is incorporated in the tire in the form of a relatively thin (e.g. 0.1 to 0.25 inch) sealant layer. A typical embodiment of the invention comprises a toroidal tubeless tire casing having the usual vulcanized rubber tread (11) and sidewall portions surmounting a vulcanized rubber carcass (14) reinforced with filamentary material, which terminates at bead areas containing the usual circumferential inextensible reinforcement. The entire inside surface of the carcass is covered by the usual air-impervious liner 17 (see FIG. 1). A layer 18 of sealant material of the invention extends across the interior crown surface of the liner from one shoulder area of the tire to the other, and extends at least part way into each interior side wall area.

The sealing action of the layer 18 is represented in FIG. 1, where a nail 19 has punctured the tire through the tread 11, carcass 14, liner 17 and sealant layer 18. The sealant composition tends to adhere to the nail and prevents loss of air pressure while the nail is in place. When the nail is withdrawn, as shown in FIG. 1, it tends to pull a plug 20 of the sealant composition into the puncture, thereby sealing the puncture against loss of air.

In a modification of the invention, (not shown), the puncture sealant layer of the invention is disposed in between the inner surface of the carcass and the liner. In such cases where the sealant layer is incorporated in the tire, it may be crosslinked before or after said incorporation. Similarly, the tire may be cured before or after incorporation of the sealant layer.

In order to apply a sealant layer to the interior surface of a tire, the composition may be prepared as a solvent cement, for example as a solution in n-hexane or other suitable volatile organic solvent. This cement may be applied (e.g. sprayed or brushed) over the desired area of the inner surface of the tire liner, using as many coats as required to build up a desired thickness. Using the hydrocarbyl titanate curative system, the thus-applied sealant layer will become sufficiently crosslinked to perform the sealant function in about five days at room temperature, although the cure time may be shortened if desired by storing the tire in a warm place, e.g., at 50 degrees to 100 degrees Celsius.

Another method is to extrude the heated sealant composition into a tire at elevated temperature in the form of a layer or strip having the desired thickness. Conveniently the composition may be extruded directly onto the liner surface from a suitably shaped die extending into the tire carcass, while rotating the tire. For extrusion at elevated temperatures, a curative system must be selected which will not react prematurely at the temperature of extrusion, but which will subsequently cure the composition at some temperature higher than the extrusion temperature. The tetrahydrocarbyl titanate ester cure of the puncture sealant represents a particularly advantageous practice of the invention in that with the tetrahydrocarbyl titanate ester curative it is possible to extrude the sealant at an elevated temperature without premature cure, and yet the cure of the applied sealant layer can be accomplished at a lower temperature (e.g. room temperature). The reason for this is that the titanate ester cure of the blend of elastomers will not take place unless hydrocarbyl alcohol (apparently formed as a by-product of the curing reaction) can escape from the composition. If the material is confined under non-evaporative conditions (e.g. in the barrel of an extruder) the cure will not take place, even at elevated temperature. However, after the blend is applied to the tire, the said hydrocarbyl alcohol is free to evaporate from the sealant layer, and the cure proceeds, even without any necessity for heating.

The puncture sealing layer may if desired cover the entire interior surface of the tire from one bead or rim area to the other, in which case the liner may be omitted and the puncture sealing layer may serve as a liner.

In some cases it may be desirable to incorporate the sealant strip in the tire assembly as the tire is being manufactured, for example by laying down a strip of the sealant material on a tire building drum, and then superimposing the liner and other carcass components. The sealant layer may be prevented from adhering to the building drum by first placing a layer of flexible material on the drum followed by the sealant layer and then the remaining components of the tire. Thus the liner may first be placed on the tire building drum, followed by the sealant layer and carcass plies.

The cure (crosslinking or gelling to an insoluble state) of unsaturated elastomer with an organo titanate ester takes place only when the mixture is exposed to the open atmosphere and can be prevented by maintaining the mixture in a closed system. The unsaturated elastomers that may be cured with titanate ester include cis-polyisoprene (whether natural or synthetic), polybutadiene, notably cis-polybutadiene, butadiene-styrene copolymer rubber, butadiene-acrylonitrile copolymer rubber, EPDM rubber (notably ethylene-propylene-5-ethylidene-2-norbomene terpolymer rubber having an iodine number greater than 8), polychloroprene rubber, butyl rubber (isoprene-isobutylene copolymer), and blends of such elastomers. The organo titanate esters employed as curatives or crosslinking agents to gel the unsaturated elastomer are tetrahydrocarbyl titanates of the formula (RO) sub 4 Ti where R is hydrocarbyl group, such as an alkyl group, e.g., an alkyl group having 1 to 12 carbon atoms, preferably 3 to 8 carbon atoms, or an aryl group having 6 to 10 carbon atoms, such as cresyl. In preparing the curable composition the mixing of the organo titanate ester crosslinking agent and unsaturated elastomer may be carried out under non-evaporative conditions in a closed system such as an internal mixer, e.g., a sigma blade mixer (such as a Baker-Perkins™ or a closed Brabender mixer™. Alternatively, the organo titanate ester may be mixed with the unsaturated elastomer in solution in an inert volatile organic solvent for the elastomer (e.g., n-hexane), preferably in the presence of a small amount of volatile alcohol (e.g., ethyl alcohol) to suppress premature gellation. Gellation then occurs only after evaporation of the solvent and alcohol. In the most typical practice the mixing is carried out under conditions which suppress gellation (i.e., in a closed system under non-evaporative conditions, or in the presence of a volatile alcohol) and then, after the mixture has been shaped into the desired form (e.g., molded, extruded, coated, etc.), the mixture is permitted to gel simply by exposing to evaporative conditions in the open atmosphere. Depending on the rubber and the amount of extraneous hydroxylic compounds such as antioxidants (hydroxylic compounds are inhibiting substances in the cure) it contains, the amount and type of titanate ester used dictate the rate and extent of cure obtained.

The temperature and time required for titanate cure again depend on the presence or absence of hydroxylic (inhibiting) additives and the type and level of titanate employed. Cure of the mixture is accompanied by evaporation of alcohol, corresponding to the alkoxy portion of the titanate ester. Hence, titanate esters of lower boiling alcohols effect cure more rapidly than titanate esters of higher boiling alcohols, e.g., isopropyl titanate acts more rapidly than butyl titanate which in turn acts more rapidly than ethylhexyl titanate. Elevated temperatures speed up the cure rate regardless of the type and level of titanate, although in the absence of added hydroxylic inhibitor and solvent cure is rapid at room temperature. In general, from 1 to 21 days are required for cure at room temperature depending on such factors as the nature of the rubber, the amount of hydroxylic impurity, the surface to volume ratio (the greater the surface exposed, the more rapid the cure), as well as the level and type of titanate ester. It is a remarkable feature of the cure that the curable mixture can be processed at elevated temperatures (under non-evaporative conditions) without premature cure, and yet cure can be accomplished at ambient temperatures (under evaporative conditions).

As indicated, it has been observed that the titanate curing reaction is accompanied by the evolution of alcohol, that is, an alcohol ROH corresponding to the organic group of the ester (RO) sub 4 Ti is generated during the cure. If the alcohol is prevented from evaporating, as in a closed container where non-evaporative conditions prevail, the cure will not go forward. However, when the curable composition is placed in the open atmosphere where evaporative conditions prevail, and the evolved alcohol ROH can escape, the cure proceeds. Thin sections such as coatings deposited from a solution, calendered or extruded films and sheets, and similar thin sections (e.g., 0.2 inch thick or less) have higher surface to volume ratio than thicker sections (such as most molded objects) and present greater opportunity for the generated alcohol ROH to escape. Therefore such thin sections cure more rapidly than thick sections.

As the titanate cure proceeds the gel content of the rubber (that is, the fraction insoluble in organic liquids that are normally solvents for the uncured elastomer) increases, indicating that crosslinking is taking place, and evolution of alcohol continues until a plateau of gel content is reached.

As indicated, hydroxylic additives have an inhibiting effect on the titanate cure. For instance phenolic antioxidants have been found to slow down the cure rate. When such antioxidants are removed as nearly as possible solutions of the rubbers tend to gel quickly when titanate esters are added. Normally, appreciable gellation occurs slowly upon evaporation of solvent from the solution. Addition of small amounts of volatile alcohol to solutions of rubber inhibits any tendency toward premature gellation. In fact, the rate of cure can be controlled by the molecular weight of the added alcohol. Low molecular weight alcohols such as ethyl alcohol have a mild or temporary inhibiting effect while higher boiling alcohols such as dodecyl alcohol have a more severe and lasting inhibiting effect. After gellation, the gelled rubber is insoluble to toluene and other organic solvents, but addition of acid such as acetic acid reverses the process and the rubber becomes soluble again. Addition of carboxylic acids likewise inhibits gel formation. It appears to be possible that the crosslinking is a consequence of titanate ester formation with the elastomer.

Preferred elastomers for use with the titanate cure are those selected from the group consisting of natural rubber, synthetic cis-polyisoprene, elastomer, cis-polybutadiene elastomer and ethylene-propylene-5-ethylidene-2-norbomene terpolymer rubber having an iodine number of at least 12, in low molecular weight (liquid) or high molecular weight (solid) form.

It will be understood that the measurements of gel content and Mooney viscosity set forth above for the final cured sealant material are obtainable on a separate sample of the sealant composition which has been subjected to curing conditions substantially equivalent to those which the final sealant material is subjected; it is of course not practical to make these measurements on an actual material in use in the tire itself.

The puncture sealant ability of the composition of the invention was tested in an inflated tire.

### EXAMPLE B 1

A sealant composition including 5 percent by weight ground rubber from used tires (40 mesh from Rouse Rubber Industries, Inc. Vicksburg, Miss.) was extruded into a tire (215/65R16) to yield a strip 7 inches wide and 0.165 inches thick. The sealant was allowed to cure at room temperature, after which the tire was mounted on a rim and inflated to 35 psi. Eight rusted, sharpened 20 penny nails, 4.8 mm in diameter and 65 mm long, were thrust into the tread, at 105 F. The tire was inflated to 35 psi with nitrogen, placed under load, and run for 7½ hours at speeds gradually increasing from 50 to 90 miles per hour. For the last half-hour, at 90 mph, all the nails were removed.

The sealing efficiency was 87.5%, versus 83.8% for the control tire whose sealant composition did not contain the ground rubber.

While a preferred embodiment of the invention has been described using specific terms, such description is for illustrative purposes only, and it is to be understood that changes and variations may be made without departing from the spirit or scope of the invention.

I claim:

1. A puncture sealing composition for a tubeless pneumatic tire comprising a fiber-free blend of
A. a minor proportion by weight of a low molecular weight liquid elastomer in admixture with a tackifying or plasticizing substance, and
B. a major proportion by weight of a high molecular weight solid elastomer, and a crosslinking agent for the elastomers in amount effective to partially crosslink the elastomers to an extent sufficient to prevent the blend from flowing at elevated temperatures and centrifugal forces encountered in the tire in use, the blend having in the partially crosslinked state sufficient adhesion and conformability to function as a sealant in the tire, the amount of (A) being from more than 50% to 10% by weight and the amount of (B) being correspondingly from less than 50% to 90% by weight, based on the combined weights of (A) and (B), the said low molecular weight elastomer being a liquid rubber having a Brookfield viscosity at 150.degree.F. of from 20,000 to 2,000,000 cps and the said high molecular weight elastomer having a Mooney viscosity of from 20 to 160 ML-4 at 212.degree.F., the said crosslinking agent being selected from the following, present in the amounts recited:
from more than 0.5 to 2.0 parts of sulfur or sulfur-yielding curative;
from more than 0.5 to 2.0 parts of quinoid curative;
from 0.1 to 1.0 part of radical generating curative;
from 2 to 10 parts of polyisocyanate curative; and
from 2 to 10 parts of tetrahydrocarbyl titanate ester curative,
the said parts of crosslinking agent being by weight based on 100 parts of the combined weight of the two elastomers, the gel content of the blend in the partially crosslinked state being from 15 to 60% by weight of the blend, as measured in toluene at room temperature, and the peak Mooney viscosity of the blend in the partially crosslinked state being from 15 to 55 ML at 150.degrees.F.; and
C. ground rubber from used tires in the amount of up to 5 percent by weight of the sealant composition.

2. A puncture sealing composition as in claim 1 in which the liquid rubber is heat depolymerized natural rubber.

3. A puncture sealing composition as in claim 1 in which the low molecular weight elastomer is selected from the group consisting of liquid cis-polyisoprene, liquid polybutadiene, liquid polybutene, liquid ethylene-propylene-non-conjugated diene terpolymer rubber, and liquid isobutylene-isoprene copolymer rubber.

4. A puncture sealing composition as in claim 1 in which the high molecular weight elastomer is selected from the group consisting of conjugated diolefin homopolymer rubbers, copolymers of a major proportion of a conjugated diolefin with a minor proportion of a copolymerizable monoethylenically unsaturated monomer, copolymers of isobutylene with a small amount of isoprene, ethylene-propylene-non-conjugated diene terpolymers, and saturated elastomers.

5. A puncture sealing composition as in claim 1 in which (A) is liquid heat depolymerized natural rubber in admixture with a resin prepared from the reaction of a mineral oil purification residue with formaldehyde and with nitric acid catalyst and (B) is solid cis-polyisoprene rubber.

6. A puncture sealing composition as in claim 1 in which the tackifying or plasticizing substance is selected from resin esters, aliphatic petroleum hydrocarbon resins, polyterpene resins, styrene resins, dicyclopentadiene resins, and resins prepared from the reaction of a mineral oil purification residue with formaldehyde and with a nitric acid catalyst.

7. A puncture sealing composition for a tubeless pneumatic tire comprising a blend of
A. from more than 50% to 10% by weight of low molecular weight liquid elastomer having a Brookfield viscosity at 150 degrees F. of from 20,000 to 1,000,000 cps in admixture with a plasticizing or tackifying substance, and
B. correspondingly from less than 50% to 90% by weight of high molecular weight solid elastomer having a Mooney viscosity of from 20 to 160 ML-4 at 212 degrees F., said blend being partially crosslinked to an extent sufficient to provide in the blend a gel content of from 20 to 50% by weight of the blend as measured in toluene at room temperature and a peak Mooney viscosity of from 15 to 55 ML at 150.degree.F., whereby the blend is prevented from flowing at elevated temperatures and centrifugal forces encountered in the tire in use and the blend has sufficient adhesion and conformability to function as a sealant in the tire
and
C. ground rubber from used tires in the amount of up to 5 percent by weight of the sealant composition.

8. A puncture sealing composition for a tubeless pneumatic tire comprising a blend of
A. from more than 50% to 10% by weight of a low molecular weight liquid elastomer having a Brookfield viscosity at 150.degree.F. of from 20,000 to 1,000,000 cps in admixture with a plasticizing or tackifying substance, and
B. correspondingly from less than 50% to 90% by weight of a high molecular weight solid elastomer having a Mooney viscosity of from 20 to 160 ML-4 at 212 degrees F., and from 2 to 10 parts, per 100 parts by weight of the two elastomers, of a tetraalkyl titanate ester crosslinking agent in which the alkyl groups have from 1 to 12 carbon atoms, said blend being partially crosslinked by the said crosslinking agent to provide in the blend a gel content of from 20% to 50% by weight based on the weight of the blend as measured in toluene at room temperature and a peak Mooney viscosity of from 15 to 55 ML at 150 degrees F., whereby the blend is prevented from flowing at elevated temperatures and centrifugal forces encountered in the tire in use and the blend has sufficient adhesion and conformability to function as a sealant in the tire, and
C. ground rubber from used tires in the amount of up to 5 percent by weight of the sealant composition.

9. A puncture sealing composition for a tubeless pneumatic tire comprising a blend of
A. from more than 50% to 10% by weight of liquid heat depolymerized natural rubber having a Brookfield viscosity at 150 degrees F. of from 20,000 to 2,000,000 cps in admixture with a plasticizing or tackifying substance, and
B. correspondingly from less than 50% to 90% by weight of cis-polyisoprene elastomer having a Mooney viscosity of from 20 to 160 ML-4 at 212 degrees F., said blend being partially crosslinked to an extent sufficient to provide in the blend a gel content of from 15 to 60% by weight of the blend as measured in toluene at room temperature and a peak Mooney viscosity of from 15 to 55 ML at 150 degrees F., whereby the blend is prevented from flowing at elevated temperatures and centrifugal forces encountered in the tire in use and the blend has sufficient adhesion and conformability to function as a sealant in the tire; and
C. ground rubber from used tires in the amount of up to 5 percent by weight of the sealant composition.

10. A puncture sealing composition for a tubeless pneumatic tire comprising a blend of
A. from more than 50% to 10% by weight of liquid heat depolymerized natural rubber having a Brookfield viscosity at 150 degrees F. of from 20,000 to 1,000,000 cps and a resin prepared from the reaction of a mineral oil purification residue with formaldehyde and with nitric acid catalyst with
B. correspondingly from less than 50% to 90% by weight of cis-polyisoprene elastomer having a Mooney viscosity of from 20 to 160 ML-4 at 212 degrees F., and from 2 to 10 parts, per 100 parts by weight of the two elastomers, of a tetraalkyl titanate ester crosslinking agent in which the alkyl groups have from 1 to 12 carbon atoms, said blend being partially crosslinked by the said crosslinking agent to provide in the blend a gel content of from 15 to 60% by weight based on the weight of the blend as measured in toluene at room temperature and a peak Mooney viscosity of from 15 to 55 ML at 150 degrees F., whereby the blend is prevented from flowing at elevated temperatures and centrifugal forces encountered in the tire in use and the blend has sufficient adhesion and conformability to function as a sealant in the tire; and
C. ground rubber from used tires in the amount of up to 5 percent by weight of the sealant composition.

12. The puncture sealing composition of claim 1, wherein the ground rubber is 40 mesh or finer.

13. A tire including the composition of any of claims 1-12.
